(19) United States
(12) Patent Application Publication
(10) Pub. No.: US 2011/0055450 A1
(43) Pub. Date: Mar. 3, 2011

(54) Multifunctional Storage Device with Built-in Software Controlled I/O Bus

(76) Inventors: David LIN, Hsinchu (TW); Victor Chiang, Hsinchu (TW); Jonathan Chen, Hsinchu (TW); Gordon Yu, Hsinchu (TW)

(21) Appl. No.: 12/547,636

(22) Filed: Aug. 26, 2009

(51) Int. Cl. G06F 13/14; G06F 12/00; G06F 3/00

(52) U.S. Cl. 710/313; 711/115; 710/13; 711/E12.001

(57) ABSTRACT

A multifunctional storage device with a built-in software controlled I/O bus includes a transmission interface plug, a transmission interface hub, at least one I/O device, at least one bridge and a built-in storage device. The built-in storage device includes a memory controller and a memory module, and the memory module stores a software program and an auto-run setup program for automatically controlling and turning on or off connected to at least one I/O device (such as an extended device including a built-in device and an external device) of the bridge, such that a user can save the trouble of installing complicated driver programs and performing a manual setup to achieve a real plug-and-play function.

### BACKGROUND OF THE INVENTION

1. Field of the Invention

The present invention relates to a multifunctional storage device with a built-in software controlled input/output (I/O) bus, in particular to a multifunctional storage device (such as a memory disk) capable of automatically running a software program to control and turn on at least one I/O device (including built-in and external I/O devices) connected to at least one bridge of the multifunctional storage device for saving the troubles of installing complicated driver programs or performing a manual configuration conducted, so as to achieve a real plug-and-play function.

2. Description of Related Art

In general, a universal serial bus (USB) interface slot is a common slot provided by small electronic devices such as notebook computers, palm computers, personal digital assistants (PDA) and digital still cameras (DSC) for installing a memory card, a modem card, a GPS card or a GPRS card having a USB interface to achieve the functions of expanding the storage of the small electronic devices, connecting a telephone call, conducting a global positioning operation, or logging on a wireless network, etc. Since the applications of the small electronic devices become increasingly broader, and the demand for expanded functions becomes increasingly higher, the small electronic device with a limited volume can provide a very limited number of USB interface slots only. Even if several USB interface slots are provided, the USB interface slots are arranged closely with one another, and users have to insert cards into these closely arranged USB interface slots, and thus the installed devices are very crowded. Some larger cards may occupy too much insertion space, such that one of the USB interface slots cannot be used.

Therefore, a conventional USB memory disk is disclosed to overcome the aforementioned problems, which mainly provides a built-in input/output USB memory disk capable of integrating various different I/O devices and memories into an electronic card in order to reduce the quantity of USB interface slots occupied by the small electronic devices.

However, the conventional technology has not provided an effective management and control of the power supply and data transmission of each bridge, although it provides the function of a USB hub to extend the connections to more small electronic devices (such as a USB interface memory card, modem, GPS and GPRS, etc) and also improves the aforementioned shortcomings of the prior art that many USB interface slots are arranged together, and users have to insert several cards in the USB interface slots at the same time, and thus the USB interface cards are too crowded, or some larger card may even occupy too much insertion space, such that one of the interface slots cannot be used.

Therefore, it is a main subject for the present invention to overcome the aforementioned shortcomings of the prior art, such that the design and technical characteristics of the invention can achieve a real plug-and-play function.

### SUMMARY OF THE INVENTION

In view of the shortcomings of the prior art, particularly the ineffective management and control of the power supply and the data transmission of each bridge and the failure of achieving a real plug-and-play function, the inventor of the present invention based on years of experience in the related industry to conduct extensive researches and experiments, and finally developed a multifunctional storage device with a built-in software controlled I/O bus in accordance with the present invention to overcome the shortcomings of the prior art.

Therefore, it is a primary objective of the present invention to provide a multifunctional storage device with a built-in software controlled I/O bus, and the storage device not just provides the expanded memory storage and I/O functions for an external electronic device to reduce the number of transmission interface slots (such as USB slots) of the external electronic device only, but also automatically runs a setup program to turn on/off at least one I/O device (which is an extended device) connected to at least one bridge automatically, such that a user can save the troubles of installing complicated driver programs and performing manual setups, and the multifunctional storage device (which is the memory disk) requires no additional setup or driver program when used in any other computer.

### BRIEF DESCRIPTION OF THE DRAWINGS

The invention, as well as its many advantages, may be further understood by the following detailed description and drawings in which:

FIG. 1 is a schematic block diagram of a hardware structure of the present invention; and

FIG. 2 is a flow chart of a start-up procedure of the present invention.

### DETAILED DESCRIPTION OF THE INVENTION

To make it easier for our examiner to understand the technical characteristics and operating procedure of the present invention, we use preferred embodiments together with the attached drawings for the detailed description of the invention as follows.

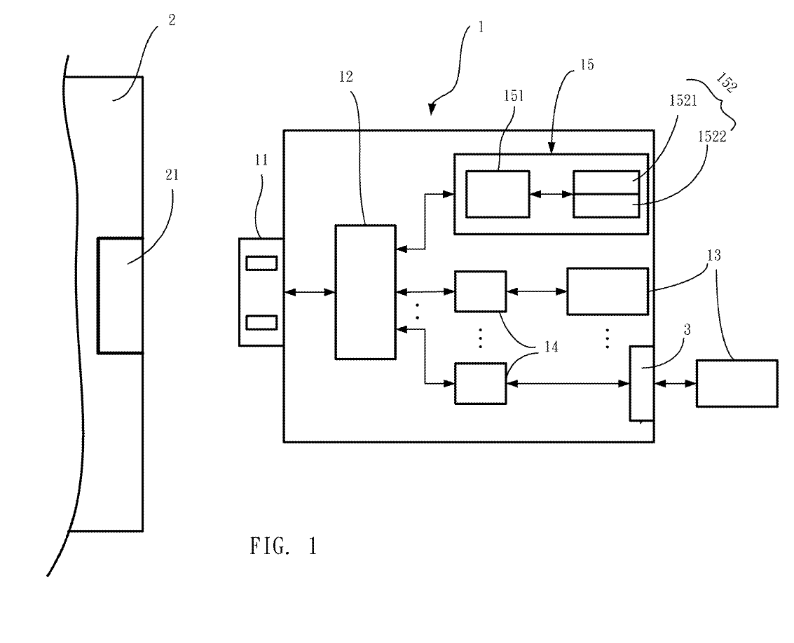

With reference to FIG. 1 for a schematic block diagram of a hardware structure of multifunctional storage device with a built-in software controlled I/O bus in accordance with the present invention, the multifunctional storage device (which is a memory disk 1) comprises a transmission interface plug 11, a transmission interface hub 12, at least one I/O device 13, at least one bridge 14 and a built-in storage device 15, wherein the transmission interface plug 11 is provided for inserting the memory disk 1 into a slot 21 of an external electronic device 2 (such as a computer) for the expanded memory storage and I/O functions of the external electronic device 2, and the transmission interface hub 12 is connected to the transmission interface plug 11 for converting a transmission interface into a plurality of transmission interfaces; and at least one I/O device 13 provides expanded memory storage and I/O functions; and at least one bridge 14 converts a transmission interface signal (such as VCC, D+, D− and GND) of the transmission interface hub 12 into an I/O interface signal of at least one I/O device 13, or converting an I/O interface signal of at least one I/O device 13 into a transmission interface signal, and the built-in storage device 15 is connected to the transmission interface hub 12 and includes a memory controller 151 and a memory module 152 provided for storage, and at least one bridge 14 allocates the signals of the transmission interface plug 11 into the I/O device 13, such that the I/O device 13 can share a transmission interface at the same time.

With the foregoing hardware structure, the technical characteristics of the present invention can be implemented as follows:

The memory controller 151 divides the memory module 152 into two parts; an auto-execution area 1521 (which is a read only area) and a general storage area 1522 (which is a read and write area), wherein the auto-execution area (or the read only area) 1521 stores a software program and a driver program required by the corresponding I/O device 13, such that the driver program can be run automatically to control and prevent users from deleting any file in the driver program accidentally, and the general storage area 1522 (or the read and write area) stores an auto-run setup program provided for a user to modify a parameter of the setup program according to the user's habit, and stores a newly added driver program for an extended use of I/O devices 13.

The transmission interface plug 11 and the transmission interface hub 12 come with an interface selected from the specifications of USB, IEEE 1394 and eSATA.

The I/O device 13 (such as a Bluetooth device or a general packet radio service (GPRS) device) can be built in the memory disk 1 or an external I/O device 13. If the memory disk 1 further includes a connector 3, and the connector 3 is connected to the external I/O device 13, and then electrically connected to the bridge 14, then a transmission interface signal (VCC, D+, D− and GND) of the transmission interface hub 12 can be converted into an I/O interface signal of the I/O device 13, or converting an I/O interface signal of the I/O device 13 into a transmission interface signal, wherein the I/O interface of the I/O device 13 is preferably a serial interface.

The memory controller 151 is a flash memory controller 151.

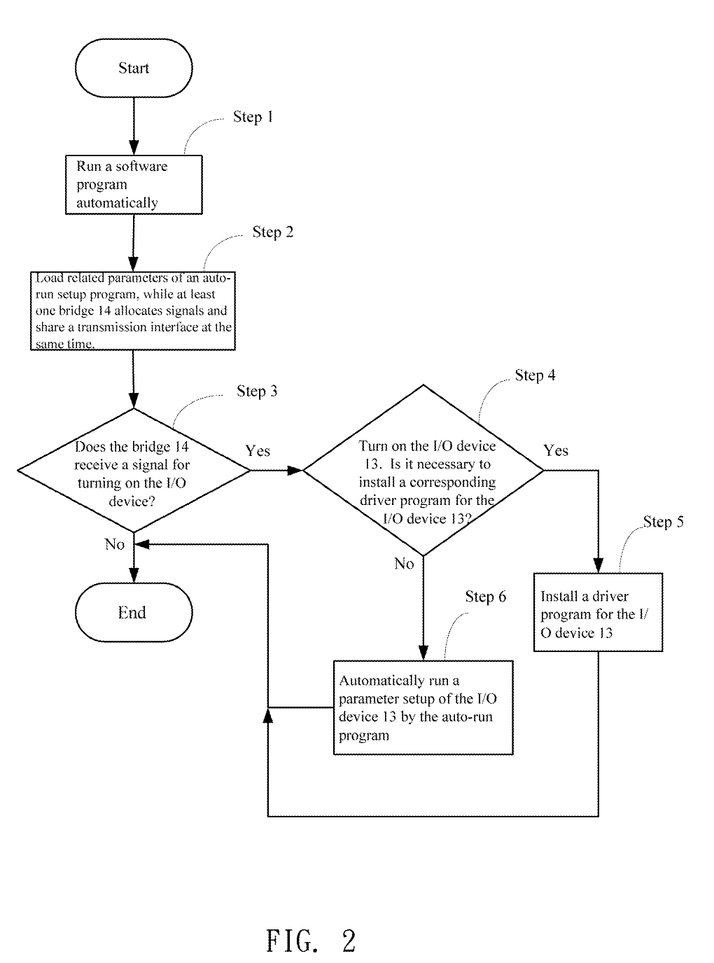

With reference to FIG. 2 for a flow chart of an auto-run procedure of a software program installed in the auto-execution area (read only area) 1521 of a multifunctional storage device (such as a memory disk 1) of the present invention after the memory disk 1 is connected to a computer, the procedure comprises the following steps:

Step 1: Run the software program automatically.

Step 2: Load related parameters of an auto-run setup program, while at least one bridge 14 allocates signals of the transmission interface plug 11 to the transmission interface plug 11 and at least one I/O device 13, such that the transmission interface plug 11 and the I/O device 13 can share a transmission interface at the same time.

Step 3: Determine whether or not the bridge 14 has received a signal for turning on the I/O device 13, and go to the next step if the signal is received, or else terminate the procedure.

Step 4: Turn on the I/O device 13, and determine whether or not it is necessary to install a corresponding driver program for the I/O device 13, and go to the next step is it is necessary to install the driver program, or else jump to Step 6.

Step 5: Install a newly added driver program for the extended use of the I/O device 13, and terminate the auto-run procedure.

Step 6: Automatically run a parameter setup of the I/O device 13 by the auto-run program, and terminate the auto-run procedure.

In summation of the description above, the memory disk 1 of the present invention not just provides the expanded memory storage and I/O functions for the external electronic device 2 to reduce the number of transmission interface slots (such as the USB slots) occupied by the external electronic devices 2 only, but also automatically turns on or off the I/O device 13 (which is an extended device) connected to the bridge 14 by the software program according to the auto-run setup program, so as to save the trouble of installing complicated driver programs and performing manual setup. In addition, the setup program for turning on or off at I/O device 13 and the driver program are stored in the built-in memory module 152, and thus the memory disk 1 of the present invention has no setup or driver installation issues when used in any other computer, so as to achieve a real plug-and-play function. Obviously, the present invention improves over the prior art and complies with patent application requirements, and thus is duly filed for patent application.

Many changes and modifications in the above described embodiment of the invention can, of course, be carried out without departing from the scope thereof Accordingly, to promote the progress in science and the useful arts, the invention is disclosed and is intended to be limited only by the scope of the appended claims.

What is claimed is:

1. A multifunctional storage device with a built-in software controlled I/O bus, comprising:
a transmission interface plug, inserted onto a slot of an external electronic device;
a transmission interface hub, connected to the transmission interface plug, for converting a transmission interface into a plurality of transmission interfaces for use;
at least one I/O device, for providing expanded memory storage and I/O functions;
at least one bridge, for converting a transmission interface signal of the transmission interface hub into an I/O interface signal of the I/O device, or converting an I/O interface signal of the I/O device into a transmission interface signal; and
a built-in storage device, connected to the transmission interface hub, and including a memory controller and a memory module provided for storage, and the bridge allocating signals of the transmission interface plug for the transmission interface plug and the I/O device, such that the transmission interface plug and the I/O device can share a transmission interface at the same time;
wherein the memory controller divides the memory module into an auto-execution area and a general storage area, wherein the auto-execution area stores a software program and a driver program required by the corresponding I/O device, and the general storage area stores an auto-run setup program for allowing a user to modify a parameter of the setup program according to the user's habit, and store a newly added driver program for an extended use of at least one I/O device.

2. The multifunctional storage device with a built-in software controlled I/O bus of claim 1, wherein the transmission interface plug and the transmission interface hub uses an interface with a specification selected from the collection of USB, IEEE 1394 and eSATA.

3. The multifunctional storage device with a built-in software controlled I/O bus of claim 2, wherein the memory controller is a flash memory controller.

4. The multifunctional storage device with a built-in software controlled I/O bus of claim 3, wherein the I/O device has an I/O interface which is a serial interface.

5. The multifunctional storage device with a built-in software controlled I/O bus of claim 4, wherein the I/O device is built in the multifunctional storage device.

6. The multifunctional storage device with a built-in software controlled I/O bus of claim 4, further comprising a connector for connecting at least one I/O device if the I/O device is an external device, and electrically connecting the bridge.

7. The multifunctional storage device with a built-in software controlled I/O bus of claim 4, wherein the I/O device transmits a control signal to the memory controller through a software program to turn on or off the I/O bus.
